(19) United States
(12) Patent Application Publication
(10) Pub. No.: US 2024/0305147 A1
(43) Pub. Date: Sep. 12, 2024

(54) SHANGHAI FLEXIV ROBOTICS TECHNOLOGY CO., LTD.

(71) Applicant: SHANGHAI FLEXIV ROBOTICS TECHNOLOGY CO., LTD., Shanghai (CN)

(72) Inventors: Ran AN, Santa Clara, CA (US); Tingke SONG, Shanghai (CN); Kun ZENG, Shanghai (CN); Chuneng CAO, Foshan City (CN); Juncai PENG, Shanghai (CN)

(21) Appl. No.: 18/041,240

(22) PCT Filed: Dec. 24, 2021
(86) PCT No.: PCT/CN2021/141122

§ 371 Date: Feb. 10, 2023

(30) Foreign Application Priority Data
Dec. 21, 2021 (CN) 202111571428.8

(51) Int. Cl. H02K 1/16; B25J 9/12; H02K 1/14; H02K 3/28; H02K 3/34

(52) U.S. Cl. CPC H02K 1/165; H02K 1/148; H02K 3/28; H02K 3/345; B25J 9/126; H02K 2213/03

(57) ABSTRACT

The present disclosure discloses a stator assembly. The stator assembly comprises: a stator core comprising a plurality of stator teeth, and any two adjacent ones of the plurality of stator teeth are provided with a stator slot therebetween; and a stator winding formed by a wire wound on the stator teeth, the stator winding being received in the stator slots. A cross section of the stator winding in a winding direction of the wire is a plurality of wires having orthohexagonal shapes, and any two adjacent ones of wires closely fit each other.

### CROSS-REFERENCE TO RELATED APPLICATIONS

This application is an U.S. national phase application under 35 U.S.C. § 371 based upon international patent application No. PCT/CN2021/141122 filed on Dec. 24, 2021, which claims priority to Chinese patent application No. 2021115714288 filed on Dec. 21, 2021. The contents of the above-identified applications are hereby incorporated herein in their entireties by reference.

### TECHNICAL FIELD

The present disclosure relates generally to the field of motors, and in particular, to a stator assembly, a motor, and a robot.

### BACKGROUND

With a widespread use of motors, performance requirements of users for motors are also increasing. In structural designs of the motor, a slot filling factor refers to a proportion of a space occupied by a wire of a stator winding in a stator slot in a cross section along an axial direction of a stator assembly after the stator winding of the stator assembly is wound on stator teeth and received in the stator slot.

Currently, the stator windings inside the motor are usually wound with wires having a circular cross-section, and gaps always exist between the wires having a circular cross-section, thereby reducing a space utilization in the stator slots. In addition, since a current flowing through the wire is usually an alternating current, a skin effect may be occurred in the wire, so that most of the current flows through a surface of the wire, which is equivalent to reducing the cross-sectional area of the wire. Therefore, as a current density through the stator winding increases, an amount of heat also increases, thereby affecting a life span of the motor.

In addition, there is also a technique for winding the stator winding by using a wire having a rectangular cross-section, in which the slot filling factor is improved when the wire having the rectangular cross-section is used, but since the wire having the rectangular cross-section has a relatively sharp edge, the wire may easily collide with each other during the winding of the wire, thereby causing scratching and/or paint removal of the surface of the wire, thereby affecting an insulation performance and the life span of the wire.

### SUMMARY

Based on this, in order to overcome one or more of the above-mentioned disadvantages, the present disclosure provides a stator assembly, a motor, and a robot that can improve a slot filling factor, reduce an influence of the skin effect, and have good stability.

Specifically, one aspect of the present disclosure provides a stator assembly comprising: a stator core comprising a plurality of stator teeth, wherein any two adjacent ones of the plurality of stator teeth are provided with a stator slot therebetween; and a stator winding formed by a wire wound on the stator teeth, the stator winding being received in the stator slots. A cross section of the stator winding in a winding direction of the wire is a plurality of wires having orthohexagonal shapes, and any two adjacent ones of the wires closely fit each other.

In one embodiment, an insulating layer is provided between the stator teeth and the stator winding wound on the stator teeth, and the insulating layer has a shape conforming to the wire wound thereon.

Further, the insulating layer defines a plurality of grooves, each of the grooves has a profile with an included angle of 120° to closely fit the wire.

Alternatively, the insulating layer comprises a resiliently deformable material.

In one embodiment, the stator teeth define a plurality of recesses, each of the recesses has a profile with an included angle of 120° to closely fit the wire.

In one embodiment, two adjacent ones of the stator teeth are respectively wound with one stator winding.

Further, sizes of the wires of the stator windings wound on two adjacent ones of the stator teeth are the same as with each other.

In one embodiment, only a wire of one stator winding is received in one of the stator slots.

Further, the wire of the one stator winding abuts opposite sides of the stator slot in one of the stator slots.

Further, insulating layers having a shape conforming to the wire are respectively provided on two sides of the wire of the stator winding opposite to the the stator slot. Further, the insulating layer defines a plurality of grooves, each of the grooves has a profile with an included angle of 120° to closely fit the wire.

Alternatively, the insulating layer comprises a resiliently deformable material.

In some embodiments, the stator core is an integrally formed structure.

In some embodiments, the stator core is formed by assembling a plurality of sector segments, each of the sector segments comprises at least one stator teeth.

In some embodiments, the wire is an enameled metal wire or an insulating sheath-coated metal wire. The enameled metal wire may use an insulating enamel material such as polyurethane, and the insulating sheath-coated metal wire may use an insulating sheath material such as polytetrafluoroethylene (PTFE).

In some embodiments, the stator slots are formed with a rectangular shape.

Another aspect of the present disclosure provides a motor comprising a rotor and a stator assembly. The stator assembly comprises: a stator core comprising a plurality of stator teeth, wherein any two adjacent ones of the plurality of stator teeth are provided with a stator slot therebetween; and a stator winding formed by a wire wound on the stator teeth, the stator winding being received in the stator slots. A cross section of the stator winding in a winding direction of the wire is a plurality of wires having orthohexagonal shapes, and any two adjacent ones of the wires closely fit each other.

In one embodiment, the rotor is provided within the stator assembly.

In one embodiment, the motor is a brushless DC motor or a permanent magnet synchronous motor.

Yet another aspect of the present disclosure provides a robot comprising a plurality of connecting arms, any two adjacent ones of the plurality of connecting arms are pivotally connected by a joint. The joint comprises a rotor and a stator assembly. The stator assembly comprises: a stator core comprising a plurality of stator teeth, wherein any two adjacent ones of the plurality of stator teeth are provided with a stator slot therebetween; and a stator winding formed by a wire wound on the stator teeth, the stator winding being received in the stator slots. A cross section of the stator winding in a winding direction of the wire is a plurality of wires having orthohexagonal shapes, and any two adjacent ones of the wires closely fit each other.

Details of one or more embodiments of the present disclosure are provided in the following drawings and description. Other features, objects and advantages of the present disclosure will become apparent upon review of the following specification, drawings, and claims.

### BRIEF DESCRIPTION OF THE DRAWINGS

The accompanying drawings, which form a part hereof, serve to provide a further understanding of the present application, and the illustrative embodiments of the present disclosure and the description thereof serve to explain the present disclosure, and are not to be construed as unduly limiting the present disclosure.

In order to explain the technical solutions in the embodiments of the present disclosure more clearly, the following will introduce briefly the drawings used in the description of the embodiments. Obviously, the drawings in the following description are merely several embodiments of the present disclosure. For those skilled in the art, other drawings can be obtained based on these drawings without creative work.

FIG. 1 is a schematic cross-sectional view of a stator assembly according to an embodiment of the present disclosure with a stator winding removed.

FIG. 2 is a partially enlarged schematic view of a portion A of the stator assembly in FIG. 1 according to an embodiment of the present disclosure.

FIG. 3 is a partially enlarged schematic view of the portion A of the stator assembly in FIG. 1 according to another embodiment of the present disclosure.

FIG. 4 is a partially enlarged schematic view of the portion A of the stator assembly in FIG. 1 according to yet another embodiment of the present disclosure.

FIG. 5 is a schematic structural view of a robot according to an embodiment of the present disclosure.

FIG. 6 is a flowchart of manufacturing a stator assembly according to an embodiment of the present disclosure.

### DETAILED DESCRIPTION OF THE EMBODIMENTS

In order that the above objects, features and advantages of the present disclosure may be more readily understood, reference will now be made in detail to the accompanying drawings. In the following description, numerous specific details are set forth in order to facilitate a thorough understanding of the present disclosure. However, the present disclosure can be embodied in many other ways than those described herein, and those skilled in the art can make similar modifications without departing from the spirit of the present disclosure, and thus the present disclosure is not limited to the specific embodiments disclosed below.

It is to be understood that although the terms “first” “second” and the like may be used herein to describe various elements, it is not intended to indicate any order, number, or importance, but merely to distinguish between different components. These terms are used only to distinguish one element from another. For example, the first element may be referred to as the second element without departing from the scope of the present application, and similarly, the second element may be referred to as the first element. “Including” or “including” and the like are intended to mean that an element or article preceding the word encompasses an element or article recited after the word and equivalents thereof, but not other elements or articles rule out.

Unless otherwise defined, all technical and scientific terms used herein have the same meaning as commonly understood by those skilled in the technical field of the present application. The terms used in the description of the present application are merely for the purpose of describing specific embodiments, and are not intended to limit the present application. The term “and/or” used herein includes any and all combinations of one or more related listed items.

Reference to “embodiments” herein means that a specific feature, structure, or characteristic described in conjunction with the embodiments may be included in at least one embodiment of the present application. An appearance of a phrase in various places in the specification does not necessarily refer to the same embodiment, nor is it an independent or alternative embodiment mutually exclusive with other embodiments. Those skilled in the art clearly and implicitly understand that, the embodiments described herein can be combined with other embodiments.

In description of the present application, orientational or positional relationships represented by technical terms, such as “length”, “width”, “vertical”, “horizontal”, etc., are orientational or positional relationships based on the drawings, and are merely for the convenience of describing the present application and simplifying the description, rather than indicating or implying that the device or element is intended to have a particular orientation, or is constructed and operated in a particular orientation, and therefore, should not be interpreted as a limitation of the present application.

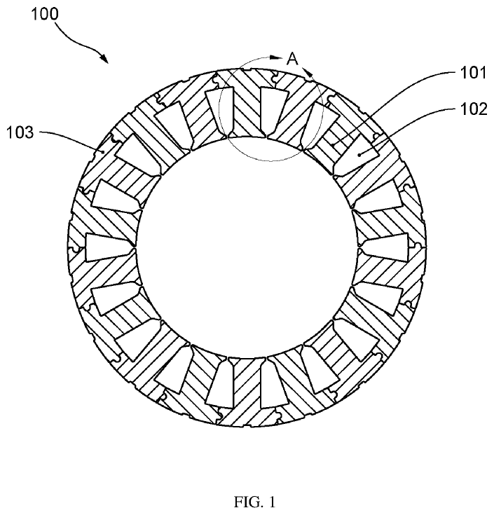

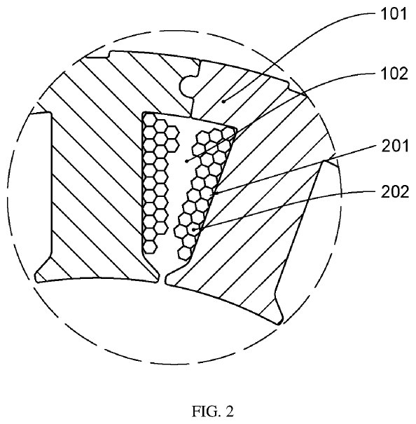

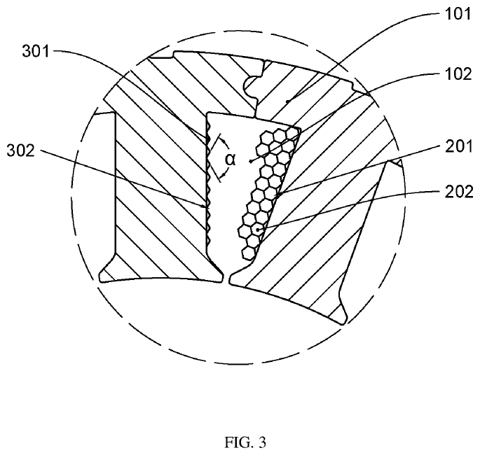

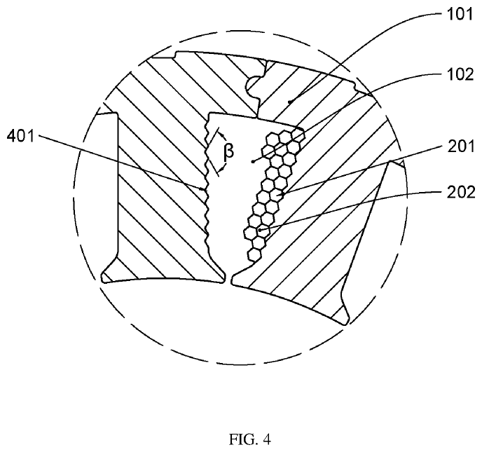

Referring now to FIGS. 1 to 4, a stator assembly 100 according to an embodiment of the present disclosure will be described. FIG. 1 is a schematic cross-sectional view of a stator assembly according to an embodiment of the present disclosure with a stator winding removed. FIG. 2 is a partially enlarged schematic view of a portion A of the stator assembly in FIG. 1 according to an embodiment of the present disclosure. FIG. 3 is a partially enlarged schematic view of the portion A of the stator assembly in FIG. 1 according to another embodiment of the present disclosure. FIG. 4 is a partially enlarged schematic view of the portion A of the stator assembly in FIG. 1 according to yet another embodiment of the present disclosure.

In FIG. 1, a stator assembly 100 is provided and shown in an axial direction of the stator assembly 100. The stator assembly 100 includes: a stator core including a plurality of stator teeth 101, and any two adjacent ones of the plurality of stator teeth 101 are provided with a stator slot 102 therebetween; and a stator winding (not shown) formed by a wire wound on the stator teeth 101, and the stator winding is received in the stator slots 102.

The stator core may be made of, for example, a silicon steel sheet, or may be made of other materials having preferred electrical and magnetic properties, such as SPCC, or other similar materials. In the embodiment shown in FIG. 1, the stator core includes a plurality of sector segments 103, and each sector segment 103 includes one stator tooth 101, whereby any two adjacent ones of the plurality of sector segments 103 are provided with one stator slot 102 therebetween. Further, the stator core can be formed by assembling a plurality of sector segments 103 through fitting structures (as shown in FIG. 1) and/or fasteners (not shown).

It should be understood that, each of the sector segments 103 may also include two or more stator teeth 101.

Alternatively, in some embodiments, the stator core may also be of an integrally formed structure or assembled by a plurality of circular segments, which are not limited herein.

Referring now to FIGS. 1 to 2, an arrangement of the stator winding in the stator slots will be described. FIG. 2 is a partially enlarged schematic view of the portion A of the stator assembly 100 in FIG. 1 according to an embodiment of the present disclosure, showing a portion of the stator winding 201.

According to an embodiment of the present disclosure, the stator winding 201 is wound on the stator tooth 101 and received in the stator slots 102. In FIG. 2, two stator teeth 101 are shown in the axial direction of the stator assembly 100, the stator slot 102 is formed between the two stator teeth 101, and two stator teeth 101 are respectively wound with one stator winding 201. For clarity, only a portion of the stator winding 201 within the stator slot 102 is shown in FIG. 2. As shown, a cross section of the stator winding 201 is a plurality of wires 202 having orthohexagonal shapes, and any two adjacent ones of the wires 202 closely fit each other.

In this condition, in the cross section of the stator winding 201, the wires 202 are formed in orthohexagonal shapes of uniform size and arranged in a honeycomb pattern, that is, any two adjacent ones of the wires 202 have a common boundary, and there is no air gap between the wires 202.

As a result, by providing the cross section of the stator winding 201 into the plurality of wires 202 having orthohexagonal shapes, and any two adjacent ones of the wires 202 closely fit each other, so that more turns of the wires 202 can be wound in the stator slot 102 of the same size, and at the same time, a slot filling factor is improved, so that the space in the stator slot 102 can be fully utilized. In addition, since with a same cross-sectional area (i.e., with a same size of material), the wires having the orthohexagonal shape have a larger circumference (about 5% larger) than the wires having the circular cross-section, the wires having the orthohexagonal shape allow a larger current to pass (because the larger the circumference, the smaller the influence of the skin effect), while also increases a power density of the motor. In addition, by forming the stator winding 201 with the wires having the orthohexagonal shape, the stator winding 201 can maintain good stability even when subjected to an external force (in particular, pressure), and is not easily compressed and loosened.

In FIG. 2, the cross section of the stator winding 201 is shown in the axial direction of the stator assembly 100, but it should be noted that, considering that the stator winding 201 is formed by winding the wire onto the stator tooth 101, it is conceivable that all of the cross section of the stator winding 201 in the winding direction of the wire 202 is a plurality of wires 202 having orthohexagonal shapes.

In addition, in the embodiment shown in FIG. 2, two adjacent ones of the stator teeth 101 are respectively wound with a stator winding 201. Further, sizes of the wires 202 of the stator windings 201 wound on these two adjacent ones of the stator teeth 101 are the same as each other. Furthermore, depending on the shape of the stator slot 102 and the number of turns of the wire 202, respective portions of the two stator windings 201 in the stator slot 102 (shown in FIG. 2 as the left and right portions in the stator slot 102) may be closely fitted or left with an air gap. Preferably, by designing the shape of the stator slot 102 and the size and number of turns of the wire 202 of the stator winding 201, respective portions of the two stator windings 201 within the stator slot 102 closely fit each other, whereby the slot filling factor can be further improved.

Preferably, the stator slot 102 can be formed in a rectangular shape, whereby the wire 202 can completely fill the stator slot 102. In addition, the stator slot 102 may be formed in another shape that can be completely filled by the wire 202, for example, a trapezoidal shape, which is not limited herein.

Furthermore, it should be understood that the wires 202 in the stator slots 102 shown in FIG. 2 may also belong to a same stator winding 201. That is, only one wire 202 of the stator winding 201 is received in one of the stator slots 102. In this condition, the wire 202 of the stator winding 201 may abut opposite sides of the stator slot 102. That is, the wire 202 of the stator winding 201 wound on one stator tooth 101 can be wound up to the adjacent stator teeth 101. Preferably, depending on the shape of the stator slot 102 and the number of turns of the wire 202, the wire 202 of the stator winding 201 wound on one stator tooth 101 can completely fill the stator slots 102 on both sides of the stator tooth 101.

Further, the stator winding 201 may be formed by winding one wire 202 around the stator tooth 101, or may be formed by winding a plurality of wires 202 around the stator tooth 101 and electrically connecting them, which is not limited herein.

Referring now to FIGS. 1 and 3, FIG. 3 is a partially enlarged schematic view of the portion A of the stator assembly 100 in FIG. 1 according to another embodiment of the present disclosure. Further, as shown in FIG. 3, an insulating layer 301 is provided between the stator tooth 101 and the stator winding 201 wound on the stator tooth 101, and the insulating layer 301 has a shape conforming to the wire 202 wound thereon. In addition, the embodiment shown in FIG. 3 is similar to the embodiment shown in FIG. 2, and therefore explanation is omitted.

In the embodiment shown in FIG. 3, the insulating layer 301 is schematically shown on one side of the stator slot 102, and the wire 202 wound on the insulating layer 301 is schematically shown on the other side of the stator slot 102.

As shown in FIG. 3, the insulating layer 301 is formed with a plurality of grooves 302 to receive the wire 202. Preferably, each of the grooves 302 has a profile with an included angle α of 120°, so as to closely fit the wire 202. The insulating layer 301 may be made of, for example, an aqueous polymeric polyester resin, which is not limited herein.

By forming the insulating layer 301 with a plurality of grooves 302, the wire 202 arranged in a honeycomb pattern can be wound in contact with the stator teeth 101 at an acute angle thereof, so that the wound wire 202 can be more stable, thereby further improving the stability of the stator winding 201.

Additionally or alternatively, the insulating layer 301 may be formed of a resiliently deformable material. Thus, when the wire 202 is wound on the insulating layer 301, the insulating layer 301 fits tightly the wire 202 by clastic deformation, and in the case of depressions occurred in the stator slot 102 due to manufacturing accuracy, the insulating layer 301 can also fill the depressions by elastic deformation. Similarly, the wound wire 202 can be more stable, thereby further improving the stability of the stator winding 201.

Referring now to FIGS. 1 and 4, FIG. 4 is a partially enlarged schematic view of the portion A of the stator assembly 100 in FIG. 1 according to yet another embodiment of the present disclosure. As shown in FIG. 4, the stator teeth 101 may also be formed with a plurality of recesses 401 to receive the wires 202. Preferably, each of the recesses 401 has a profile with an included angle β of 120°, so as to closely fit the wire 202. In addition, the embodiment shown in FIG. 4 is similar to the embodiment shown in FIG. 2, and therefore explanation is omitted.

In the embodiment shown in FIG. 4, a plurality of recesses 401 is schematically shown on one side of the stator slot 102, and the wire 401 wound on the plurality of recesses 401 is schematically shown on the other side of the stator slot 102. Similarly, by forming a plurality of the recesses 401 for winding the wire 202, the wire 202 arranged in a honeycomb pattern can be wound in contact with the stator teeth 101 at an acute angle thereof, so that the wound wire 202 can be more stable, thereby further improving the stability of the stator winding 201.

It should also be noted that the insulating layer 301 shown in FIG. 3 may be formed on the recesses 401. In addition, it should be appreciated that, although in FIGS. 3 and 4, the insulating layer 301, the grooves 302, or the recesses 401 are formed on both sides of the stator slot 102 adjacent to the stator tooth 101, the insulating layer 301, the grooves 302, or the recesses 401 may be formed on all sides of the stator slot 102, or may be formed on all sides of the stator tooth 101, as required by design.

Further, in some embodiments, the wire 202 may be an enameled metal wire or an insulating sheath-coated metal wire. Further, the enameled metal wire may use an insulating enamel material such as polyurethane, and the insulating sheath-coated metal wire may use an insulating sheath material such as polytetrafluoroethylene (PTFE).

Furthermore, another aspect of the present disclosure provides a motor including a rotor and any of the stator assemblies described in the above embodiments.

Further, the rotor may be provided within the stator assembly. Of course, the rotor may be provided in other ways, and is not limited herein.

Further, the motor may be, for example, a brushless direct current motor (BLDC) or a permanent magnet synchronous motor (PMSM) for use in a robot or a joint of the robot.

By providing a stator assembly as described above, more turns of wires can be wound in a stator slot of the same size, and at the same time, the slot filling factor is improved, so that the space in the stator slot can be fully utilized. In addition, since with a same cross-sectional area, the wires having the orthohexagonal shape have a larger circumference than the wires having the circular cross-section, the wires having the orthohexagonal shape allow a larger current to pass while also increases a power density of the motor, so that the motor can be widely applied to fields and applications such as robotics and motor development. In addition, by forming the stator winding with the wires having the orthohexagonal shape, the stator winding can maintain good stability even when subjected to an external force, and is not easily compressed and loosened.

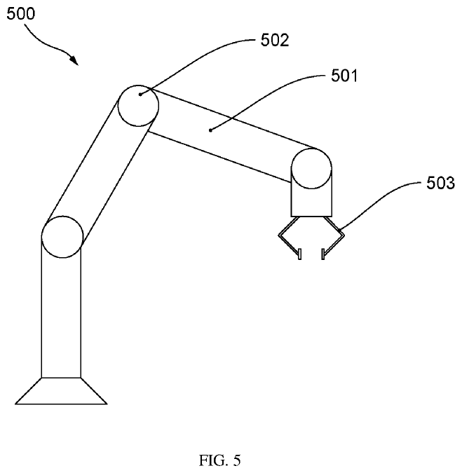

Referring now to FIGS. 5, a robot according to an embodiment of the present disclosure will be described. FIG. 5 is a schematic structural view of a robot according to an embodiment of the present disclosure. As shown, the robot 500 may include a plurality of connecting arms 501, any two adjacent ones of the plurality of connecting arms 501 are pivotally connected by respective joints 502, which may employ the motor as described above, such as a brushless DC motor (BLDC) or a permanent magnet synchronous motor (PMSM). The robot 500 further includes a robot clamping jaw 503. One end of the robot clamping jaw 503 is connected to a corresponding connecting arm 501, and the other end of the robot clamping jaw 503 is provided with one or more gripping means. Thus, the robot 500 can be configured to clamp or grip articles. It should be understood by those skilled in the art that the structure shown in FIG. 5 is merely an exemplary embodiment of the robot 500. In other embodiments, robot 500 may include more or fewer components, such as additional connecting arms and end effectors. Some components (e.g., two or more connecting arms) may be combined, and components of a different or additional type than those depicted may be employed. For example, the robot may also include an I/O device, a network access device, a communication bus, a processor, a memory, an actuator, and a sensor to enable control of the system. For example, the robot 500 may include a processor and a memory that stores instructions that, when executed by the processor, enable the processor to control the system. The memory may also store instructions that, when executed by the processor, enable the processor to activate or deactivate the robot clamping jaw 503 to grip or release articles to be clamped.

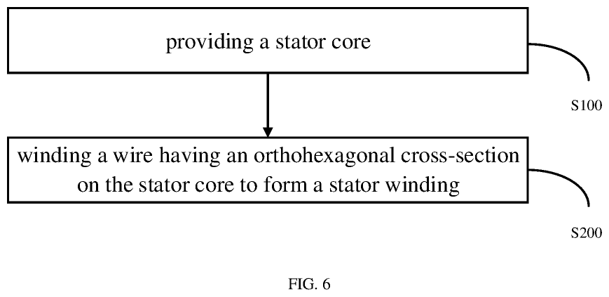

Referring now to FIG. 6, FIG. 6 is a flowchart of manufacturing a stator assembly according to an embodiment of the present disclosure. As shown, another aspect of the present disclosure provides a method of manufacturing a stator assembly including the steps of:

S100, providing a stator core. The stator core includes a plurality of stator teeth, and any two adjacent ones of the plurality of stator teeth are provided with a stator slot therebetween.

S200, winding a wire having an orthohexagonal cross-section on the stator teeth to form a stator winding, so that a cross section of the stator winding in a winding direction of the wire is a plurality of wires having orthohexagonal shapes, and any two adjacent ones of the wires closely fit each other.

Further, before the step S200, the method may further include a step of providing an insulating layer between the stator tooth and the stator winding wound thereon. The insulating layer has a shape conforming to the wire wound thereon. Specifically, the insulating layer may be formed with a plurality of grooves to receive the wire. Preferably, each of the grooves has a profile with an included angle of 120°, so as to closely fit the wire. Alternatively, the insulating layer is formed of a resiliently deformable material.

Further, in the step S200 of winding the wire having an orthohexagonal cross-section on the stator teeth to form a stator winding, the method may include winding a first stator winding and a second stator winding with a first wire and a second wire on adjacent first stator tooth and second stator tooth, respectively. Preferably, the first wire and the second wire are sized to be same as each other. Further, the number of turns of the first wire on the first stator winding and the number of turns of the second wire on the second stator winding may be the same or different according to design requirements. Preferably, by designing a shape of the stator slot between the first stator tooth and the second stator tooth and the size and number of turns of the first wire and the second wire, respective portions of the first stator winding and the second stator winding in the stator slot are also closely fitted each other.

Alternatively, in the step S200 of winding the wire having an orthohexagonal cross-section on the stator teeth to form a stator winding, the method may include winding one wire onto the stator teeth to form the stator winding so that the stator winding can abut opposite sides of the stator slots on both sides of the stator teeth.

However, the stator winding may also be formed by winding a plurality of wires around the stator teeth and electrically connecting them.

By forming the stator assembly with the method as described above, more turns of wires can be wound in a stator slot of the same size, and at the same time, the slot filling factor is improved, so that the space in the stator slot can be fully utilized. In addition, since with a same cross-sectional area, the wires having the orthohexagonal shape have a larger circumference than the wires having the circular cross-section, the wires having the orthohexagonal shape allow a larger current to pass while also increases a power density of the motor, so that the motor can be widely applied to fields and applications such as robotics and motor development. In addition, by forming the stator winding with the wires having the orthohexagonal shape, the stator winding can maintain good stability even when subjected to an external force, and is not easily compressed and loosened.

In description of the present disclosure, it should be understood that orientational or positional relationships represented by directional terms, such as “central”, “longitudinal”, “lateral”, “length”, “width”, “thickness”, “up”, “down”, “front”, “rear”, “left”, “right”, “vertical”. “horizontal”, “top”, “bottom”. “inside”, “outside”, “clockwise”, “anticlockwise”, “axial”, “radial”, “circumferential” etc., are orientational or positional relationships based on the drawings, and are merely for the convenience of describing the present disclosure and simplifying the description, rather than indicating or implying that the device or element is intended to have a particular orientation, or is constructed and operated in a particular orientation, and therefore, should not be interpreted as a limitation of the present disclosure.

In addition, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In description of the present disclosure, “a plurality of” means more than two, unless otherwise specifically defined.

In the present disclosure, unless otherwise clearly specified and limited, the terms “installed”, “connected”, “coupled”, “fixed” and other terms should be understood in a broad sense, for example, it can be a fixed connection or a detachable connection, or integrated; it can be mechanically connected or electrically connected; it can be directly connected or indirectly connected through an intermediary, it can be the internal communication of two components or the interaction relationship between two components, unless otherwise specified the limit. For those skilled in the art, the specific meanings of the above terms in the present disclosure can be understood according to specific circumstances.

The technical features of the above described embodiments can be combined arbitrarily. To simplify the description, not all possible combinations of the technical features in the above embodiments are described. However, all of the combinations of these technical features should be considered as within the scope of the present application, as long as such combinations do not contradict with each other.

The foregoing embodiments are merely some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements belong to the protection scope of the present disclosure. Therefore, the protection scope of the present disclosure shall be subject to the protection scope of the appended claims.

1. A stator assembly comprising:
a stator core comprising a plurality of stator teeth, wherein any two adjacent ones of the plurality of stator teeth are provided with a stator slot therebetween; and
a stator winding formed by a wire wound on the stator teeth, the stator winding being received in the stator slots,
wherein a cross section of the stator winding in a winding direction of the wire is a plurality of wires having orthohexagonal shapes, and any two adjacent ones of the wires closely fit each other.

2. The stator assembly according to claim 1, wherein an insulating layer is provided between the stator teeth and the stator winding wound on the stator teeth, and the insulating layer has a shape conforming to the wire wound thereon.

3. The stator assembly according to claim 2, wherein the insulating layer defines a plurality of grooves, each of the grooves has a profile with an included angle of 120° to closely fit the wire.

4. The stator assembly of claim 2, wherein the insulating layer comprises a resiliently deformable material.

5. The stator assembly according to claim 1, wherein the stator teeth define a plurality of recesses, each of the recesses has a profile with an included angle of 120° to closely fit the wire.

6. The stator assembly according to claim 1, wherein two adjacent ones of the stator teeth are respectively wound with one stator winding.

7. The stator assembly according to claim 6, wherein sizes of the wires of the stator windings wound on two adjacent ones of the stator teeth are the same as each other.

8. The stator assembly of claim 1, wherein only a wire of one stator winding is received in one of the stator slots.

9. The stator assembly according to claim 8, wherein the wire of the one stator winding abuts opposite sides of the stator slot in one of the stator slots.

10. The stator assembly according to claim 9, wherein insulating layers having a shape conforming to the wire are respectively provided on two sides of the wire of the stator winding opposite to the stator slot.

11. The stator assembly according to claim 10, wherein the insulating layer defines a plurality of grooves, each of the grooves has a profile with an included angle of 120° to closely fit the wire.

12. The stator assembly of claim 10, wherein the insulating layer comprises a resiliently deformable material.

13. The stator assembly according to claim 1, wherein the stator core is an integrally formed structure.

14. The stator assembly according to claim 1, wherein the stator core is formed by assembling a plurality of sector segments, each of the sector segments comprises at least one stator teeth.

15. The stator assembly according to claim 1, wherein the wire is an enameled metal wire or an insulating sheath-coated metal wire.

16. The stator assembly according to claim 1, wherein the stator slot is formed with a rectangular shape.

17. A motor comprising a rotor and the stator assembly according to claim 1.

18. The motor according to claim 17, wherein the rotor is provided within the stator assembly.

19. The motor according to claim 17, wherein the motor is a brushless DC motor or a permanent magnet synchronous motor.

20. A robot comprising a plurality of connecting arms, any two adjacent ones of the plurality of connecting arms being pivotally connected by a joint, wherein the joint comprises the motor according to claim 17.
